(19) United States
(12) Patent Application Publication
(10) Pub. No.: US 2010/0310966 A1
(43) Pub. Date: Dec. 9, 2010

(54) COAXIAL FUEL CELL OR ELECTROLYSER MODULE WITH BALL INTERCONNECTORS

(75) Inventor: Jean-Luc Sarro, Bourg Saint Andeol (FR)

Correspondence Address: Nixon Peabody LLP, P.O. Box 60610, Palo Alto, CA, 94306, US

(73) Assignee: Commissariat A L'Energie Atomique, Paris (FR)

(21) Appl. No.: 12/675,962

(22) PCT Filed: Aug. 29, 2008
(86) PCT No.: PCT/EP2008/061380

§ 371 Date: Mar. 1, 2010

(30) Foreign Application Priority Data
Sep. 3, 2007 (FR) 0757328

(51) Int. Cl. H01M 8/10

(52) U.S. Cl. 429/495

(57) ABSTRACT

Elementary electro-chemical cells and interconnectors composed firstly of a gas separation tube and secondly of a plurality of balls occupy the spaces between these gas separation tubes and elementary cells, are thus inserted alternately. The balls allow uniform distribution of gas on cell operational surfaces and increase the number of electrical contacts between the separation tubes and the elementary cells.

### CROSS REFERENCE TO RELATED APPLICATIONS OR PRIORITY CLAIM

This application is a national phase of International Application No. PCT/EP2008/061380, entitled, “COAXIAL MODULE FOR FUEL CELL OR ELECTROLYSER WITH BALL INTERCONNECTORS”, which was filed on Aug. 29, 2008, and which claims priority of French Patent Application No. 07 57328, filed Sep. 3, 2007.

### DESCRIPTION

1. Field of the Invention

The invention relates to both fuel cells and electrolysers and particularly fuel cells operating at a high temperature such as SOFC (Solid Oxide Fuel Cell) type fuel cells and SOEC (Solid Oxide Electrolyser Cell) type electrolysers.

Nevertheless, the invention may also be applied to other families of fuel cells and electrolysers.

2. Prior Art and Problem that Arises

SOFC type fuel cells operate with oxygen as oxidant and hydrogen as fuel, or with another combustible gas for example such as methane, at a temperature of between 500 and 1000° C. These fuel cells are composed of a stack of several elementary cells connected by connection elements such as interconnectors or bipolar plates. The elementary cells are composed of a stack of a cathode, an electrolyte and an anode. The high temperature is necessary to obtain sufficient conductivity of the electrolyte in O₂ ions. A SOEC electrolyser functions like an inverted SOFC fuel cell. It produces hydrogen from steam and electrical energy.

Several types of architectures are used in the design of fuel cells. There are four main types:
tubular or axial architecture;
monolithic architecture
strip architecture;
plane architecture.

Progress in materials used for solid oxide electrochemical cells enables lower operating temperature of these units, without sacrificing existing performances. Under these conditions, the use of metallic components for interconnectors is feasible and reduces the construction cost. Furthermore, French patent application FR 2 877 498 deposited by the same applicant describes an axial fuel cell architecture providing a solution for putting electrochemical cells electrically into series with each other. FIG. 1 shows this type of fuel cell construction. It is composed mainly of a central stack 2 of several elementary fuel cells, separated from each other by interconnectors 1. These interconnectors are composed of a central metallic partition fitted with flexible scalloped collars. The box is complemented by a base 5 and a flange 4, the two of which clamp the stack 2 together and distribute and recover combustible gases and their residues.

FIG. 2 shows details of the type of interconnectors used. In fact, the figure shows half of an interconnector. This interconnector is composed mainly of a central partition 13 composed of a semi-cylindrical metallic plate. Collars 11 are fixed on each of its faces at intervals from each other, so as to project on each side of the sealed partition 13 in an inclined manner. The sealed partition 13, which is tubular in shape, is designed to separate the two gases used and to participate in putting the various cells in series. The function of the collars 11 is to put the electrochemical cells in series by contact. They also enable assembly, while absorbing differences in expansion between the cells and the interconnectors, so as to maintain contact when hot.

It is fairly expensive to produce such an interconnector with collars or strips because it requires the use of an alloy with a high resistance to creep, to maintain contact in the long term. Furthermore, contact points are relatively well spaced, which leads to resistive losses during the circulation of the electrons in the electrodes.

The purpose of the invention is to contribute extending the life of this type of equipment, by avoiding the need to rely on elasticity of materials forming the interconnectors and to reduce its manufacturing cost.

### SUMMARY OF THE INVENTION

To achieve this, the main purpose of the invention is a SOFC (Solid Oxide Fuel Cell) module and a SOEC (Solid Oxide Electrolyser Cell) with an axial structure composed of elementary cells with tubular geometry, each cell being composed of a concentric stack comprising an anode, an electrolyte and a cathode, each cell being surrounded by two interconnectors, the module being composed of a concentric stack of several concentric cells and complemented by a distribution and exhaust device, namely a base and a flange, on each side.

According to the invention, each of the interconnectors is composed of a plurality of metallic balls, compacted between cells and separation tubes stacked coaxially and alternately with the cells.

In the preferred configuration of the invention, the section of the module is cylindrical.

In the preferred embodiment of the invention, a ring is used between the base and the stack to terminate the separation tubes to break gas flows arriving through the base in the intervals, between the cells and separation tubes.

In this case, it is advantageous to provide a shoulder with a slope on the ring so as to facilitate the distribution of balls around 360° when the intervals are filled with balls.

A variant of the invention consists of coating the balls with different coatings to create a ball protection gradient as a function of the operating conditions and the location at which they are located along the entire length of the module.

It is also advantageous to use a seal on the upper surface of the base to maintain the seal between the seal and the stack. This seal may be glass-ceramic or slip glass.

### LIST OF FIGURES

The invention and its different technical characteristics will be better understood after reading the following description accompanied by several figures representing the following:

FIG. 1, already described shows a fuel cell according to prior art with an axial configuration;

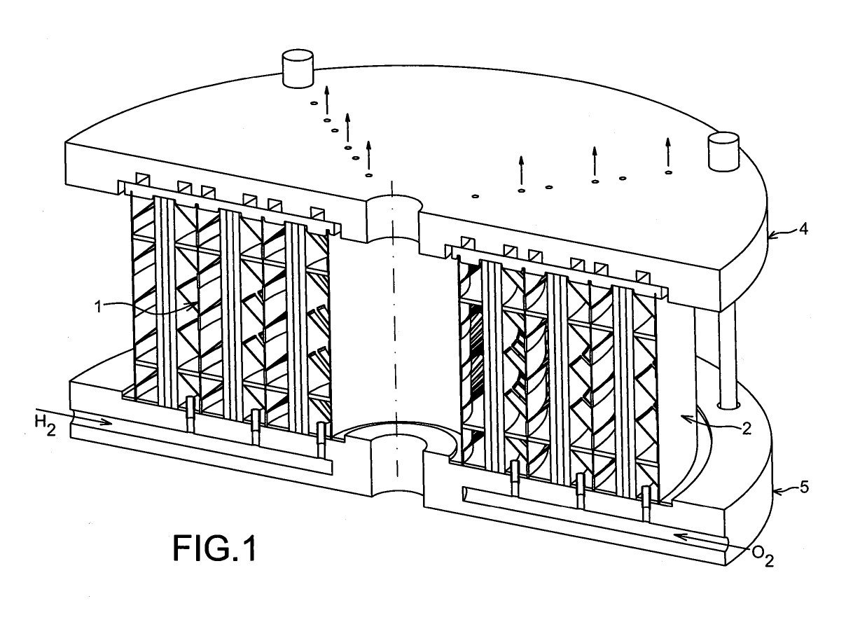

FIG. 2 shows a strip interconnector used in the type of fuel cells described in FIG. 1;

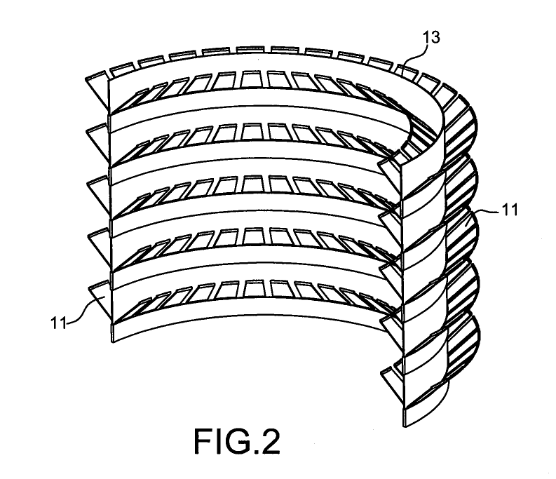

FIG. 3 shows the design of ball interconnectors used in the module according to the invention;

FIG. 4 shows details of the base junction and two stages of the stack in the module according to the invention;

FIG. 5 shows a half-section showing the entire module according to the invention with two stages of cells;

FIG. 6 shows an exploded view of the base and the sole plate used in the module according to the invention.

### DETAILED DESCRIPTION OF ONE EMBODIMENT OF THE INVENTION

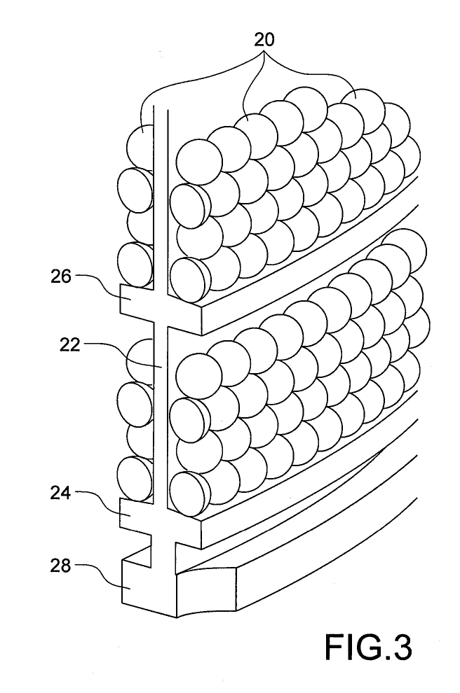

With reference to FIG. 3, the interconnector according to the invention comprises mainly a tubular separator tube 22 made of ferritic stainless steel or any other metallic alloy with a low coefficient of expansion. Its functions are to hold the balls used in place, to put the electrochemical cells into electrical series with each other and to separate gases. The materials mentioned above are much less expensive than materials based on nickel and their machinability is comparable to the machinability of a conventional stainless steel. If oxidation is observed on the material forming the separation tube 22 so that the surface of this separation tube remains a good electrical conductor and forms an efficient barrier against evaporation of chromium, a coating can be made to perform the same function.

The second functional element is composed of a plurality of balls 20 placed on each side of the separation tube 22 and that should also come into contact with one of the two cells adjacent to the interconnector. Therefore the function of the balls 20 is to put the electrochemical cells electrically in series with other through separation tubes 22, despite the possible expansion differential between these different components. The balls 20 also perform a gas diffusion role and enable installation of the assembly without needing to depend on elasticity of the material.

FIG. 3 also shows the presence of a ring 24 placed immediately above a base 28 on this interconnector. It may be added on by welding or it may be machined in the body. Its functions are to keep the bottom balls in contact with it in position, to prevent gas inlets from becoming obstructed by these balls and to homogenise the gas distribution by breaking the gas jet arriving below and to guide it throughout the entire circumference of the module. Recesses, not shown, are machined in the ring 24, vertically in line with the gas inlets, to enable the gas to pass through.

A slight slope can be seen on the upper surface of the ring 24 to allow good distribution of the balls during filling, so that they can fill the entire space between the separation tube 22 and two adjacent cells. One or several horizontal partitions 26 may be provided to compartmentalise the large number of balls used so as to better distribute and reduce friction between the balls. In the latter case, all the spaces will be filled with balls using a funnel type tooling, lowering the tube as the chambers are filled.

In the case in which chromium does not evaporate uniformly over the entire length of the module, it is useful to provide a coating to maintain electronic conduction providing a barrier function against evaporation of chromium.

It would also be possible to stack strata of balls 20 with different coatings, so as to create a protection gradient as a function of the gases present and their concentration in the zone considered. For example, in the case of a SOFC type fuel cell with a hydrogen inlet through the bottom, it is possible to stack uncoated balls in the zone in which the steam concentration is sufficiently low, and then to stack coated balls or balls provided with a formation of conducting oxides.

This type of stack can be inverted in the case of a SOEC type electrolyser with a steam inlet near the bottom.

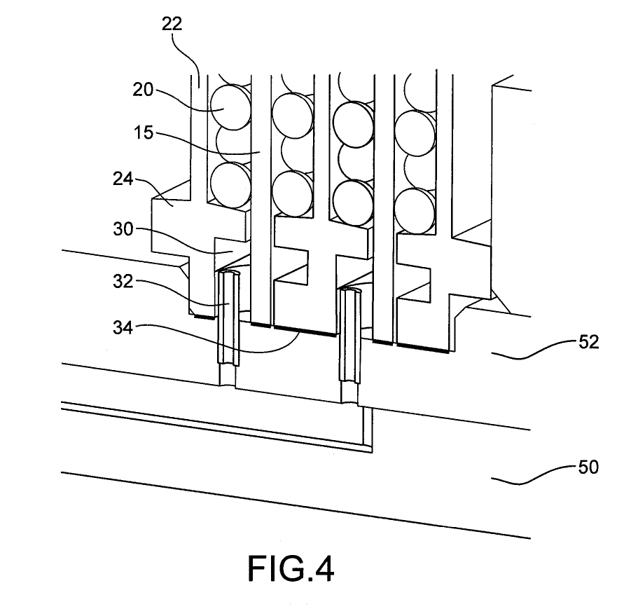

FIG. 4 shows a detail of the base of the stack of the module according to the invention. Only two cells 15 and three interconnectors are shown, but a large number of these elements could be envisaged over the entire radius of the stack.

Therefore, the electrochemical cells 15 are tubular and have an increasing radius and are mounted one inside the other. For the interconnectors 22, it should be noted that the balls 20 fill the entire annular spaces remaining between the separation tubes 22 and the cells 15.

The module has a base 50 that acts like a gas distribution box. It is envisaged to make it from ferritic stainless steel, or any other metallic alloy with a low coefficient of expansion. It is provided with two general gas supply tubes connected to an external supply, or to another cell or another electrolyser. A sole plate 52 is provided between the base 50 and the module stack. The sole plate can be made from zirconium and it contributes to the distribution of gases in the anode and cathode chambers. It also electrically isolates the assembly to avoid short circuiting the fuel cell. It expands in the same way as the cells, to relieve the sole plate during thermal transient phases.

The seal between the base 50 and the sole plate 52 is made by a glass-ceramic joint that may be deposited by plasma torch or by a slip glass seal.

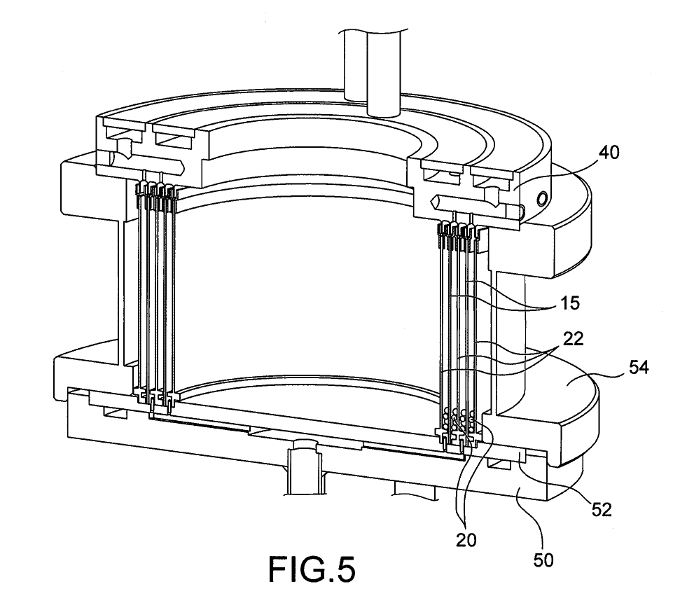

A section through the module assembly is shown in FIG. 5. This figure shows the base 50, the sole plate 52 supporting the stack composed of interconnectors and cells 15, all supporting a flange 40 that collects gases and their residues. Note that a support tube 54 surrounds the stack of the cells 15 and interconnectors. Finally, this FIG. 5 also shows balls 20 in the bottom of the stack placed between the separation tubes 22 and the cells 15.

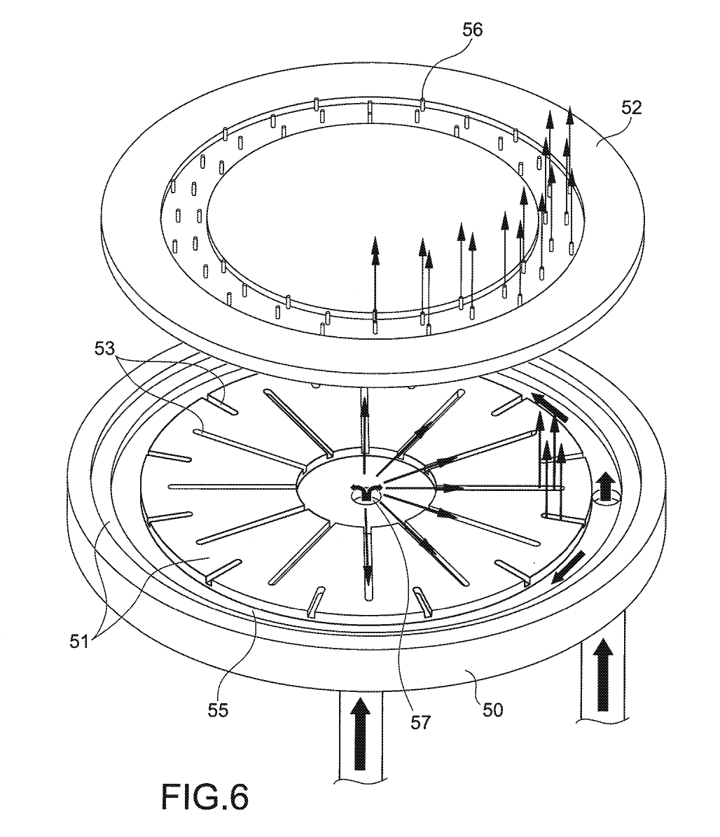

FIG. 6 shows the base 50 and the sole plate 52 mentioned above, detached from each other. The base 50 has an upper surface covered by the seal, which may be either made of glass-ceramic or slip glass.

This FIG. 6 shows gas distribution channels 53 around the entire radius of the stack between all cells and their corresponding interconnectors. The up arrows show that when the module is positioned vertically, there will be an upwards gas flow in the assembly. The sole plate 52 is equipped with holes in which capillaries 56 are placed that will penetrate into a groove 30 as shown in FIG. 4, adjacent to the ring 24 of each separation tube 22. These capillaries 56 prevent the feed channels from getting obstructed by the glass of a seal that is spread over the entire upper surface of the sole plate 52.

It will be seen that a clamping device is necessary to block the assembly making up this module. However, this device is not shown.

The global gas circulation is axial, in co-current or in reverse current. Only the axial co-current version has been described above. It will be understood that gases open up into an annular channel 55 and a central cylindrical chamber 57 that supplies the radial channels 53. Thus, the gases are transferred into their corresponding operational chamber through orifices formed in the sole plate 52, provided with capillaries 56. Gases react in contact with the electrodes as disclosed in the first section of this application, along the chambers containing the balls. Spent or converted gases are collected by the flange 40 (FIG. 5) and oriented towards an outlet or another fuel cell or another electrolyser.

Electrical power supply is collected at the module terminals, in other words on the internal and external interconnectors.

### Advantages of the Invention

The presence of balls obviously increases contact points between cells and gas separation tubes.

The distribution of gases in the operational chambers and therefore over the surface of the electrodes is very much improved by the presence of the balls.

The manufacturing cost of this module is relatively low compared with the cost of manufacturing disclosed in prior art.

Finally, it is obvious that the life of the assembly is longer than elastic solutions.

1. SOFC (Solid Oxide Fuel Cell) type Fuel cell module with axial configuration, composed of elementary cells, with tubular geometry, each cell being composed of a basic concentric stack comprising an anode, an electrolyte and a cathode, each cell being surrounded by two interconnectors, the module being composed of a concentric stack of several cells and complemented by a distribution and exhaust device, namely a base and a flange, on each side,
characterised in that each of the interconnectors is composed of a plurality of metallic balls, compacted between cells on each side of the separation tubes stacked coaxially and alternately between the cells.

2. Module according to claim 1, characterised in that the section of the module is cylindrical.

3. Module according to claim 1, characterised in that the base of the separation tubes is provided with a ring to contribute to distributing gas flows incoming through the base into the intervals formed by the cells and the separation tubes.

4. Module according to claim 3, characterised in that the ring has a shoulder with a slight slope, so as to support and distribute the balls.

5. Module according to claim 1, characterised in that the balls have different coatings.

6. Module according to claim 1, characterised in that it has a sole plate inserted between the base and the stack, a seal being provided on the upper surface of the base.

7. Module according to claim 6, characterised in that the seal is a glass-ceramic seal.

8. Module according to claim 6, characterised in that the seal of the base is a slip glass seal.

9. Module according to claim 6, characterised in that a glass seal is installed on the upper surface of the sole plate.

10. SOEC (Solid Oxide Electrolyser Cell) type electrolyser module with an axial configuration, composed of elementary cells, with tubular geometry, each cell being composed of a basic concentric stack comprising an anode, an electrolyte and a cathode, each cell being surrounded by two interconnectors, the module being composed of a concentric stack of several cells and complemented by a distribution and exhaust device, namely a base and a flange, on each side,
characterised in that each of the interconnectors is composed of a plurality of metallic balls, compacted between cells on each side of the separation tubes stacked coaxially and alternately between the cells.

11. Module according to claim 10, characterised in that it has a cylindrical section.

12. Module according to claim 10, characterised in that the bases of the separation tubes are provided with a ring to contribute to distributing gas flows incoming through the base into the intervals formed by the cells and the separation tubes.

13. Module according to claim 12, characterised in that the ring has a shoulder with a slight slope, so as to support and distribute the balls.

14. Module according to claim 10, characterised in that the balls have different coatings.

15. Module according to claim 10, characterised in that it has a sole plate inserted between the base and the stack, a seal being provided on the upper surface of the base.

16. Module according to claim 15, characterised in that the seal is a glass-ceramic seal.

17. Module according to claim 15, characterised in that the seal of the base is a slip glass seal.

18. Module according to claim 15, characterised in that a glass seal is installed on the upper surface of the sole plate.
